(19) United States
(12) Patent Application Publication
(10) Pub. No.: US 2026/0185491 A1
(43) Pub. Date: Jul. 2, 2026

(54) OPERATION METHOD FOR GAS TURBINE

(71) Applicant: MITSUBISH HEAVY INDUSTRIES, LTD., Tokyo (JP)

(72) Inventors: Satoshi TANIMURA, Tokyo (JP); Sosuke NAKAMURA, Tokyo (JP); Tomo KAWAKAMI, Tokyo (JP); Teruhiro MATSUMOTO, Tokyo (JP); Mitsuhiro MORISHITA, Tokyo (JP); Shohei DOMEN, Tokyo (JP); Akinori ICHIKAWA, Tokyo (JP)

(21) Appl. No.: 19/128,683

(22) PCT Filed: Nov. 21, 2023
(86) PCT No.: PCT/JP2023/041777

§ 371 Date: May 9, 2025

(30) Foreign Application Priority Data
Dec. 1, 2022 (JP) 2022-192566

(51) Int. Cl. F02C 9/40; F02C 3/22; F02C 3/30

(52) U.S. Cl. CPC F02C 9/40; F02C 3/22; F02C 3/30

(57) ABSTRACT

An operation method for a gas turbine according to one embodiment is for a gas turbine provided with a combustor that has a main nozzle and a pilot nozzle and that is capable of using, as fuel, hydrogen and a fuel other than hydrogen. In the operation method for the gas turbine according to said one embodiment, with regard to the ratio of the hydrogen co-combustion rate of the fuel injected from the pilot nozzle to the hydrogen co-combustion rate of the fuel injected from the main nozzle, when compared with a first ratio during operation at a low hydrogen co-combustion rate, a second ratio during operation at a high hydrogen co-combustion rate, during which the hydrogen co-combustion rate is higher than that during the operation at the low hydrogen co-combustion rate, is higher.

### TECHNICAL FIELD

The present disclosure relates to an operation method for a gas turbine.

The present application claims priority based on Japanese Patent Application No. 2022-192566 filed in Japan on Dec. 1, 2022, the contents of which are incorporated herein by reference.

### BACKGROUND ART

For example, in a thermal power plant, as means for reducing a discharge amount of carbon dioxide (CO₂), which is a cause of global warming, it is being considered to improve power generation efficiency or actively use fuel such as hydrogen other than fossil fuel (for example, refer to PTL 1).

### CITATION LIST

### Patent Literature

[PTL 1] Japanese Unexamined Patent Application Publication No. 2021-046949

### SUMMARY OF INVENTION

### Technical Problem

In order to reduce the discharge amount of the carbon dioxide, it is desirable to increase a co-combustion rate of the hydrogen. However, since the hydrogen has small ignition energy and a high combustion speed, when the co-combustion rate of the hydrogen is increased, a possibility of backflow of a flame, or the like increases.

In view of the above-described circumstances, an object of at least one embodiment of the present disclosure is to increase a hydrogen co-combustion rate while suppressing backflow of a flame, or the like when operating a gas turbine.

### Solution to Problem

(1) An operation method for a gas turbine according to at least one embodiment of the present disclosure is
an operation method for a gas turbine including a combustor that has a main nozzle and a pilot nozzle and that is capable of using, as fuel, hydrogen and fuel other than hydrogen,
in which a ratio of a hydrogen co-combustion rate of the fuel injected from the pilot nozzle to a hydrogen co-combustion rate of the fuel injected from the main nozzle is larger in a second ratio during an operation at a high hydrogen co-combustion rate, in which a hydrogen co-combustion rate is higher than during an operation at a low hydrogen co-combustion rate, than in a first ratio during the operation at the low hydrogen co-combustion rate.

### Advantageous Effects of Invention

According to at least one embodiment of the present disclosure, it is possible to increase a hydrogen co-combustion rate while suppressing backflow of a flame, or the like when operating a gas turbine.

### BRIEF DESCRIPTION OF DRAWINGS

FIG. 1 is a schematic configuration view illustrating a gas turbine according to some embodiments.

FIG. 2 is a sectional view illustrating a combustor according to some embodiments.

FIG. 3 is a sectional view illustrating a main part of the combustor according to some embodiments.

FIG. 4 is a view schematically illustrating a disposition of each fuel nozzle when the combustor according to some embodiments is viewed from a downstream side to an upstream side along an axial direction of the combustor.

FIG. 5 is a view illustrating an outline of a supply system for fuel for the combustor according to some embodiments.

FIG. 6A is a graph illustrating an example of a relationship between hydrogen co-combustion rates of respective combustion burners and a hydrogen co-combustion rate in a whole combustor during a rated operation.

FIG. 6B is a graph illustrating an example of a relationship between a ratio of a hydrogen co-combustion rate in a pilot combustion burner to a hydrogen co-combustion rate in a main combustion burner and the hydrogen co-combustion rate in the whole combustor when the hydrogen co-combustion rates of the respective combustion burners and the hydrogen co-combustion rate in the whole combustor have the relationship illustrated in FIG. 6A.

FIG. 7A is a graph illustrating another example of the relationship between the hydrogen co-combustion rates of the respective combustion burners and the hydrogen co-combustion rate in the whole combustor during the rated operation.

FIG. 7B is a graph illustrating an example of the relationship between the ratio of the hydrogen co-combustion rate in the pilot combustion burner to the hydrogen co-combustion rate in the main combustion burner and the hydrogen co-combustion rate in the whole combustor when the hydrogen co-combustion rates of the respective combustion burners and the hydrogen co-combustion rate in the whole combustor have the relationship illustrated in FIG. 7A.

FIG. 8A is a graph illustrating still another example of the relationship between the hydrogen co-combustion rates of the respective combustion burners and the hydrogen co-combustion rate in the whole combustor during the rated operation.

FIG. 8B is a graph illustrating an example of the relationship between the ratio of the hydrogen co-combustion rate in the pilot combustion burner to the hydrogen co-combustion rate in the main combustion burner and the hydrogen co-combustion rate in the whole combustor when the hydrogen co-combustion rates of the respective combustion burners and the hydrogen co-combustion rate in the whole combustor have the relationship illustrated in FIG. 8A.

FIG. 9A is a graph illustrating an example of the relationship between the hydrogen co-combustion rates of the respective combustion burners and the hydrogen co-combustion rate in the whole combustor during a partial load operation.

FIG. 9B is a graph illustrating an example of the relationship between the ratio of the hydrogen co-combustion rate in the pilot combustion burner to the hydrogen co-combustion rate in the main combustion burner and the hydrogen co-combustion rate in the whole combustor when the hydrogen co-combustion rates of the respective combustion burners and the hydrogen co-combustion rate in the whole combustor have the relationship illustrated in FIG. 9A.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

### About Gas Turbine 1

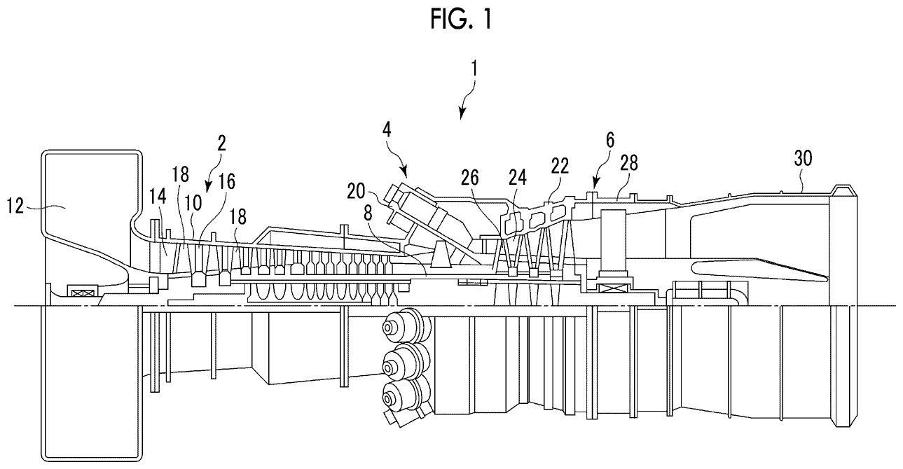

FIG. 1 is a schematic configuration view illustrating a gas turbine 1 according to some embodiments.

A gas turbine, which is an example of an application target of an operation method for a gas turbine according to some embodiments, will be described with reference to FIG. 1.

As illustrated in FIG. 1, the gas turbine 1 operated by the operation method for a gas turbine according to some embodiments includes a compressor 2 for generating compressed air as an oxidizer, a gas turbine combustor 4 for generating combustion gas by using the compressed air and fuel, and a turbine 6 configured to be rotationally driven by the combustion gas. In a case of the gas turbine 1 for power generation, a generator (not illustrated) is connected to the turbine 6, and power generation is performed by rotational energy of the turbine 6. In the following description, the gas turbine combustor 4 will also be simply referred to as a combustor 4.

Specific configuration examples of each part in the gas turbine 1 according to some embodiments will be described.

The compressor 2 according to some embodiments includes a compressor casing 10, an air intake port 12 provided on an inlet side of the compressor casing 10 to take in air, a rotor 8 provided to penetrate both the compressor casing 10 and a turbine casing 22 to be described later, and various blades disposed in the compressor casing 10. The various blades include an inlet guide blade 14 provided on a side of the air intake port 12, a plurality of stator vanes 16 fixed to a side of the compressor casing 10, and a plurality of rotor blades 18 embedded in the rotor 8 to be alternately arranged with respect to the stator vanes 16. The compressor 2 may include other components such as a bleed air chamber (not illustrated). In such a compressor 2, the air taken in from the air intake port 12 passes through the plurality of stator vanes 16 and the plurality of rotor blades 18 and is compressed to be high-temperature and high-pressure compressed air. The high-temperature and high-pressure compressed air is sent from the compressor 2 to the combustor 4 in a rear stage.

The combustor 4 according to some embodiments is disposed inside a casing 20. As illustrated in FIG. 1, a plurality of the combustors 4 may be disposed annularly around the rotor 8 in the casing 20. The combustor 4 is supplied with the fuel and the compressed air generated by the compressor 2, and combusts the fuel to generate combustion gas which is a working fluid of the turbine 6. The combustion gas is sent from the combustor 4 to the turbine 6 in the rear stage. A configuration example of the combustor 4 according to some embodiments will be described later.

The turbine 6 according to some embodiments includes the turbine casing 22 and various blades disposed within the turbine casing 22. The various blades include a plurality of stator vanes 24 fixed to a side of the turbine casing 22, and a plurality of rotor blades 26 embedded in the rotor 8 to be alternately arranged with respect to the stator vanes 24. The turbine 6 may include other components such as an outlet guide blade. In the turbine 6, the rotor 8 is rotationally driven by causing the combustion gas to pass through the plurality of stator vanes 24 and the plurality of rotor blades 26. In this way, the generator connected to the rotor 8 is driven.

An exhaust chamber 30 is connected to a downstream side of the turbine casing 22 through an exhaust casing 28. After the turbine 6 is driven, the combustion gas is discharged to an outside via the exhaust casing 28 and via the exhaust chamber 30.

### About Combustor 4

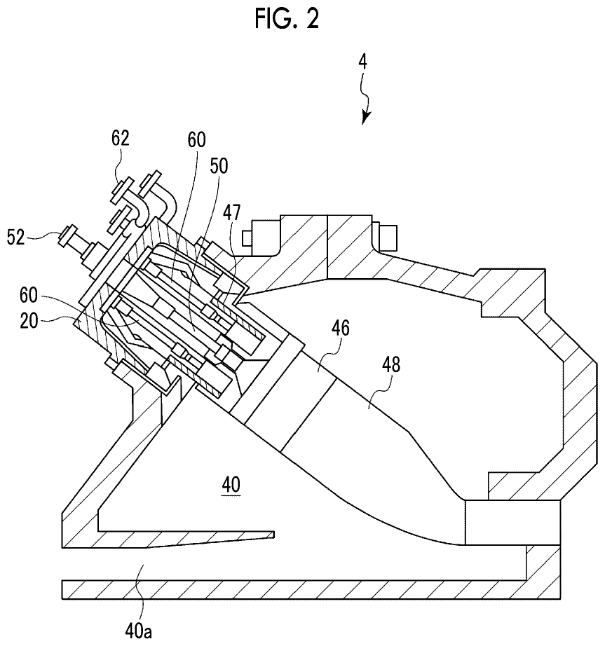

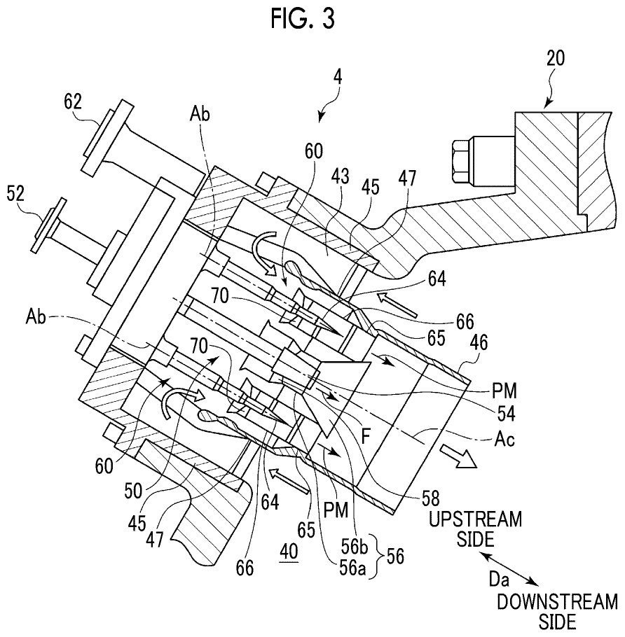

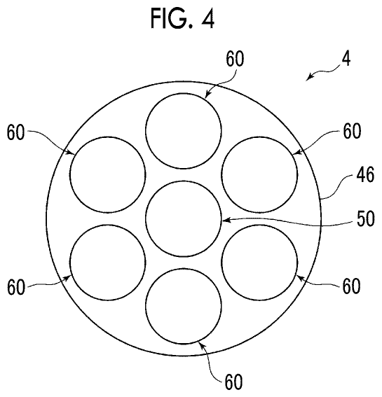

FIG. 2 is a sectional view illustrating the combustor 4 according to some embodiments. FIG. 3 is a sectional view illustrating a main part of the combustor 4 according to some embodiments. FIG. 4 is a view schematically illustrating a disposition of each fuel nozzle when the combustor 4 according to some embodiments is viewed from a downstream side to an upstream side along an axial direction of the combustor 4.

A configuration of the combustor 4 according to some embodiments will be described with reference to FIGS. 2, 3, and 4.

As illustrated in FIGS. 2 and 3, the plurality of the combustors 4 according to some embodiments are disposed annularly around the rotor 8 (refer to FIG. 1). Each of the combustors 4 includes a combustor liner 46 provided in a combustor casing 40 defined by the casing 20, and a main combustion burner 60 and a pilot combustion burner 50 which are fuel nozzles disposed in the combustor liner 46, respectively.

The combustor 4 further includes an outer cylinder 45 provided on an outer peripheral side of an inner cylinder 47 of the combustor liner 46 inside the casing 20. An air passage 43 through which the compressed air flows is formed on the outer peripheral side of the inner cylinder 47 and an inner peripheral side of the outer cylinder 45.

The combustor 4 may include other components such as a bypass pipe (not illustrated) for bypassing the combustion gas.

For example, the combustor liner 46 includes the inner cylinder 47 disposed around the pilot combustion burner 50 and a plurality of the main combustion burners 60, and a transition piece 48 connected to a tip portion of the inner cylinder 47. That is, the combustor liner 46 corresponds to a combustion portion in which fuel F injected from the main combustion burner 60 and from the pilot combustion burner 50 is combusted.

As illustrated in FIGS. 3 and 4, the pilot combustion burner 50 is disposed along a central axis of the combustor liner 46. The plurality of the main combustion burners 60 are disposed side by side to be spaced apart from each other in a circumferential direction to surround an outer peripheral side of the pilot combustion burner 50.

As illustrated in FIG. 3, the pilot combustion burner 50 includes a pilot nozzle 54 connected to a fuel port 52, a pilot burner cylinder 56 disposed to surround the pilot nozzle 54, and a plurality of swirlers (swirl plates) 58 provided on an outer periphery of the pilot nozzle 54.

The pilot nozzle 54 extends in an axial direction Da about a combustor axis Ac. Here, an upstream side which is one side in the axial direction Da, which is an extending direction of the combustor axis Ac, and is along a flow of the combustion gas is an upstream side, and a downstream side which is the other side and is along the flow of the combustion gas is a downstream side. In addition, the combustor axis Ac is also a burner axis of the pilot combustion burner 50.

An injection hole (not illustrated) for injecting the fuel F is formed in a downstream-side end portion of the pilot nozzle 54. The plurality of swirl plates 58 are provided on an upstream side of a position where the injection hole is formed in the pilot nozzle 54. Each of the swirl plates 58 is for swirling the compressed air about the combustor axis Ac. Each of the swirl plates 58 extends in a direction including a radial component from the outer periphery of the pilot nozzle 54 and is close to an inner peripheral surface of the pilot burner cylinder 56. The pilot burner cylinder 56 has a main body portion 56a located on the outer periphery of the pilot nozzle 54, and a cone portion 56b which is connected to a downstream side of the main body portion 56a and of which a diameter gradually increases toward the downstream side. The plurality of swirl plates 58 are close to an inner peripheral surface of the main body portion 56a in the pilot burner cylinder 56.

The pilot nozzle 54 has a flow path (not illustrated) of water for suppressing a flame temperature to suppress NOₓ and suppress a metal temperature of the cone portion 56b, and is configured to inject the water.

The main combustion burner 60 includes a main nozzle 64 connected to a fuel port 62, a main burner cylinder 66 disposed to surround the main nozzle 64, an extension pipe 65 that connects the main burner cylinder 66 and the combustor liner 46 (for example, inner cylinder 47), and a swirler (swirl plate) 70 provided on an outer periphery of the main nozzle 64.

The main nozzle 64 is a rod-shaped nozzle that extends in the axial direction Da about a burner axis Ab parallel to the combustor axis Ac. Since the burner axis Ab of the main combustion burner 60 is parallel to the combustor axis Ac, the axial direction Da with respect to the combustor axis Ac and the axial direction Da with respect to the burner axis Ab are the same direction. In addition, the upstream side in the axial direction Da with respect to the combustor axis Ac is an upstream side in the axial direction Da with respect to the burner axis Ab, and the downstream side in the axial direction Da with respect to the combustor axis Ac is a downstream side in the axial direction Da with respect to the burner axis Ab.

An injection hole for injecting the fuel F is formed in an intermediate portion of the main nozzle 64 in the axial direction Da. A plurality of the swirl plates 70 are provided in a vicinity of a position where the injection hole is formed in the main nozzle 64. Each of the swirl plates 70 is for swirling the compressed air about the burner axis Ab. Each of the swirl plates 70 extends in a direction including a radial component from the outer periphery of the main nozzle 64 and is close to an inner peripheral surface of the main burner cylinder 66. The main burner cylinder 66 is located on the outer periphery of the main nozzle 64.

In the combustor 4 having the above-described configuration, the compressed air generated by the compressor 2 is supplied from a casing inlet 40a into the combustor casing 40, and further flows from the combustor casing 40 into the pilot burner cylinder 56 and into a plurality of the main burner cylinders 66 via the air passage 43.

In the pilot combustion burner 50, the fuel F injected from the pilot nozzle 54 is jetted from a downstream end of the pilot burner cylinder 56 together with the compressed air. The fuel F is diffused and combusted or premixed and combusted in the combustor liner 46.

That is, the pilot combustion burner 50 illustrated in FIGS. 2, 3, and 4 is a diffusion combustion type or pre-mixed combustion type fuel nozzle.

In the main combustion burner 60, the compressed air and the fuel F injected from the main nozzle 64 are mixed in the main burner cylinder 66 to form premixed gas PM. In the main combustion burner 60, the premixed gas PM is jetted from a downstream end of the extension pipe 65. The fuel F in the premixed gas PM is premixed and combusted in the combustor liner 46.

That is, the main combustion burner 60 illustrated in FIGS. 2, 3, and 4 is a pre-mixed combustion type fuel nozzle.

An injection hole for injecting the fuel F may be formed in the swirl plate 70, and the fuel F may be injected into the main burner cylinder 66 through the injection hole. In this case, a portion corresponding to the rod-shaped main nozzle 64 described above forms a hub rod, and a main nozzle is formed with the hub rod and the plurality of the swirl plates 70. The fuel F from the outside is supplied into the hub rod, and the fuel F is supplied from the hub rod to the swirl plate 70.

### About Fuel F

The combustor 4 according to some embodiments is configured to, as the fuel F, use natural gas, for example, as in the case of a combustor in the related art, as well as hydrogen. In the following description, natural gas as the fuel F is referred to as natural gas fuel FN or simply as natural gas. Similarly, in the following description, hydrogen as the fuel F is referred to as hydrogen fuel FH or simply as hydrogen.

In addition, in the following description, when there is no need to particularly distinguish the natural gas fuel FN, the hydrogen fuel FH, and mixed fuel FM of the natural gas fuel FN and the hydrogen fuel FH, or when these types of fuel are collectively referred to, the types of fuel are referred to as fuel F.

### About Supply System for Fuel F

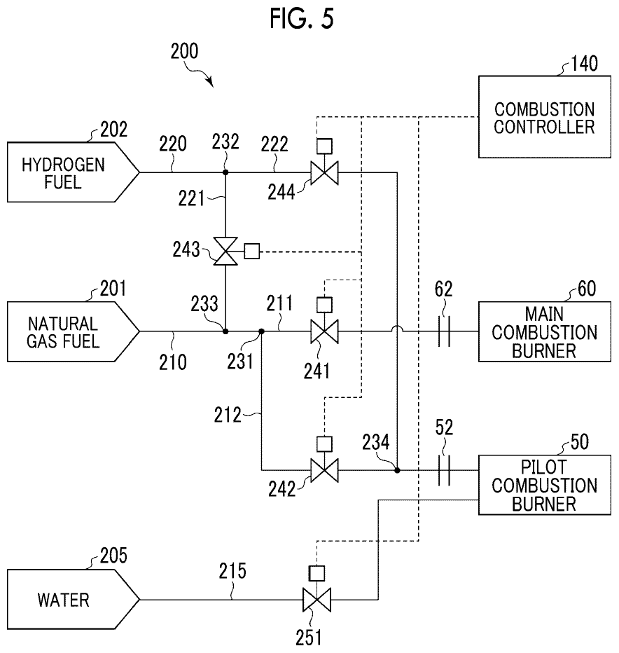

FIG. 5 is a view illustrating an outline of a supply system 200 for the fuel F for the combustor 4 according to some embodiments. The gas turbine 1 according to some embodiments includes the supply system 200 for the fuel F illustrated in FIG. 5. The supply system 200 for the fuel F illustrated in FIG. 5 includes a first supply line 211 for supplying the natural gas fuel FN to the main combustion burner 60, a second supply line 212 for supplying the natural gas fuel FN to the pilot combustion burner 50, a third supply line 221 for supplying the hydrogen fuel FH to the main combustion burner 60 and to the pilot combustion burner 50, and a fourth supply line 222 for supplying the hydrogen fuel FH to the pilot combustion burner 50.

The natural gas fuel FN is supplied from a supply source 201 for the natural gas fuel FN via a natural gas supply line 210. The first supply line 211 and the second supply line 212 branch at a branching portion 231.

The first supply line 211 is provided with a first regulation valve 241 for regulating a supply amount of the fuel F to the main combustion burner 60. A downstream end of the first supply line 211 is connected to the fuel port 62 to which the main nozzle 64 of the main combustion burner 60 is connected.

The second supply line 212 is provided with a second regulation valve 242 for regulating a supply amount of the fuel F to the pilot combustion burner 50. A downstream end of the second supply line 212 is connected to the fuel port 52 to which the pilot nozzle 54 of the pilot combustion burner 50 is connected.

The hydrogen fuel FH is supplied from a supply source 202 for the hydrogen fuel FH via a hydrogen supply line 220. The third supply line 221 and the fourth supply line 222 branch at a branching portion 232.

The third supply line 221 is provided with a third regulation valve 243 for regulating a supply amount of the hydrogen fuel FH to the main combustion burner 60 and to the pilot combustion burner 50. A downstream end of the third supply line 221 is connected to the natural gas supply line 210 at a merging portion 233 on an upstream side of the branching portion 231 in the natural gas supply line 210.

That is, the third regulation valve 243 is a regulation valve for regulating an amount of the hydrogen fuel FH added to the natural gas fuel FN flowing through the natural gas supply line 210.

The fourth supply line 222 is provided with a fourth regulation valve 244 for regulating a supply amount of the hydrogen fuel FH to the pilot combustion burner 50. A downstream end of the fourth supply line 222 is connected to the second supply line 212 at a merging portion 234 on a downstream side of the second regulation valve 242 in the second supply line 212.

That is, the fourth regulation valve 244 is a regulation valve that can regulate the amount of the hydrogen fuel FH added to the natural gas fuel FN flowing through the second supply line 212 or to the mixed fuel FM of the natural gas fuel FN and the hydrogen fuel FH. As will be described later, only the hydrogen fuel FH can be supplied to the pilot combustion burner 50 by closing the second regulation valve 242 and opening the fourth regulation valve 244.

In the supply system 200 for the fuel F configured in this way, a hydrogen co-combustion rate (calorie ratio), which is a ratio of the hydrogen fuel FH in the injected fuel F in the main combustion burner 60 and in the pilot combustion burner 50, can be regulated by regulating opening degrees of the first regulation valve 241, the second regulation valve 242, the third regulation valve 243, and the fourth regulation valve 244.

A control of the hydrogen co-combustion rate in the combustor 4 according to some embodiments will be described in detail later.

The first regulation valve 241, the second regulation valve 242, the third regulation valve 243, and the fourth regulation valve 244 are controlled by a controller configured to control each of the regulation valves. In some embodiments, the controller is realized by a combustion controller 140 of the gas turbine 1.

Each processing function of the combustion controller 140 is configured by software (computer program) and is executed by a computer, but is not limited thereto, and may be configured by hardware.

### About Supply of Water

The gas turbine 1 according to some embodiments includes a water supply line 215 for supplying cooling water to the pilot combustion burner 50. Although detailed description is omitted, the flame temperature that rises when a hydrogen co-combustion rate in the pilot combustion burner 50 is increased is suppressed by supplying the cooling water, so that a generation of NOₓ is suppressed and the metal temperature of the cone portion 56b of the pilot combustion burner 50 can be suppressed.

The cooling water can be supplied to the pilot combustion burner 50 from a supply source 205 for the water via the water supply line 215.

The water supply line 215 is provided with a water supply amount regulation valve 251 for regulating a supply amount of the water to the pilot combustion burner 50. Although detailed description is omitted, the water supply amount regulation valve 251 is controlled by the combustion controller 140.

### About Control of Hydrogen Co-Combustion Rate

For example, in a facility such as the gas turbine 1 that discharges carbon dioxide (CO₂) that causes global warming, it is required to reduce a discharge amount of carbon dioxide. For example, in order to reduce the discharge amount of the carbon dioxide in the gas turbine 1, it is desirable to increase a co-combustion rate of the hydrogen. However, since the hydrogen has small ignition energy and a high combustion speed, when the co-combustion rate of the hydrogen is increased, a possibility of backflow of a flame, or the like increases.

Meanwhile, a risk of the backflow (backfire) of the flame varies depending on a structure of the fuel nozzle (combustion burner), a disposition position of the fuel nozzle, and the like. Therefore, the risk of the backfire is not the same for all the fuel nozzles in a plurality of the fuel nozzles. Specifically, for example, the risk is as follows.

In embodiments illustrated in FIGS. 2, 3, and 4, the main combustion burner 60 is a pre-mixed combustion type fuel nozzle, and the pilot combustion burner 50 is a diffusion combustion type or pre-mixed combustion type fuel nozzle.

In general, the diffusion combustion type fuel nozzle is a fuel nozzle that has a smaller risk of the backfire than the pre-mixed combustion type fuel nozzle. Therefore, in the embodiments illustrated in FIGS. 2, 3, and 4, the pilot combustion burner 50 is a fuel nozzle having a smaller risk of the backfire than the main combustion burner 60.

In general, in a case where the fuel nozzle is surrounded by a plurality of other fuel nozzles, the fuel nozzle surrounded by the fuel nozzles has a smaller risk of the backfire than the fuel nozzles surrounding the fuel nozzle.

Here, in the embodiments illustrated in FIGS. 2, 3, and 4, the plurality of the main combustion burners 60 are disposed around the pilot combustion burner 50. Therefore, as in a case where the main combustion burner 60 and the pilot combustion burner 50 are both diffusion combustion type or pre-mixed combustion type fuel nozzles in the embodiments illustrated in FIGS. 2, 3, and 4, in a case where structures of the fuel nozzles are the same in the main combustion burner 60 and the pilot combustion burner 50, the pilot combustion burner 50 is a fuel nozzle having a smaller risk of the backfire than the main combustion burner 60.

Therefore, in the operation method for a gas turbine according to some embodiments, the gas turbine 1 is operated as follows in consideration of these.

As described above, since the pilot combustion burner 50 is a fuel nozzle having a smaller risk of the backfire than the main combustion burner 60, an upper limit value Crpmax of a hydrogen co-combustion rate Crp in the pilot combustion burner 50 is set to be larger than an upper limit value Crmmax of a hydrogen co-combustion rate Crm in the main combustion burner 60. In this manner, while suppressing the backfire, a maximum value Cromax of a hydrogen co-combustion rate Cro in a whole combustor 4 can be increased.

More specifically, in the combustor 4 according to some embodiments, the hydrogen co-combustion rate is controlled as follows.

The hydrogen co-combustion rate Cro in the whole combustor 4 is a ratio of total hydrogen fuel FH to total fuel F injected from the plurality of the main combustion burners 60 and from the pilot combustion burner 50 in one combustor, which is expressed in a calorie ratio.

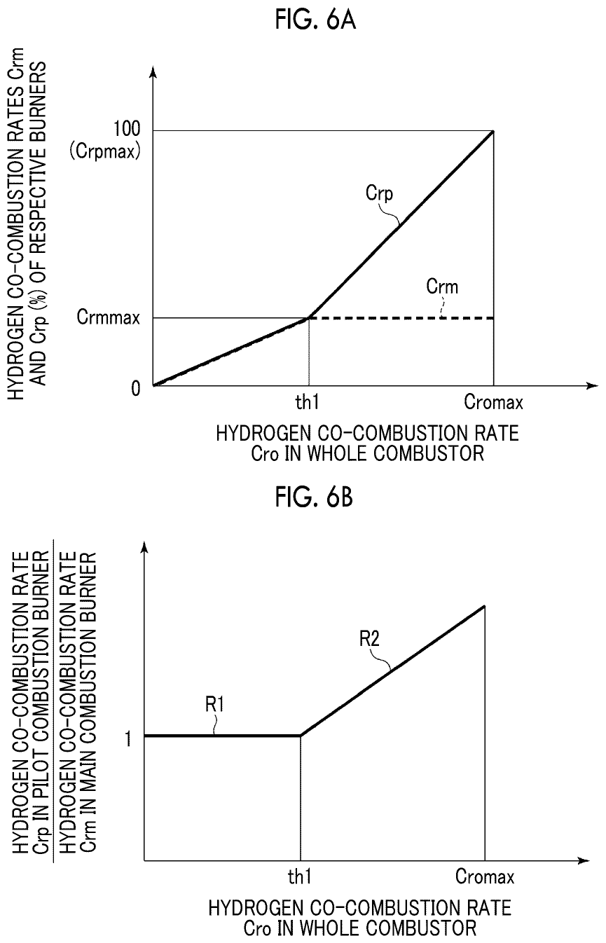

FIG. 6A is a graph illustrating an example of a relationship between the hydrogen co-combustion rates Crm and Crp of the respective combustion burners and the hydrogen co-combustion rate Cro in the whole combustor 4 during a rated operation.

FIG. 6B is a graph illustrating an example of a relationship between a ratio (Crp/Crm) of the hydrogen co-combustion rate Crp in the pilot combustion burner 50 to the hydrogen co-combustion rate Crm in the main combustion burner 60 and the hydrogen co-combustion rate Cro in the whole combustor 4 when the hydrogen co-combustion rates Crm and Crp of the respective combustion burners and the hydrogen co-combustion rate Cro in the whole combustor 4 have the relationship illustrated in FIG. 6A.

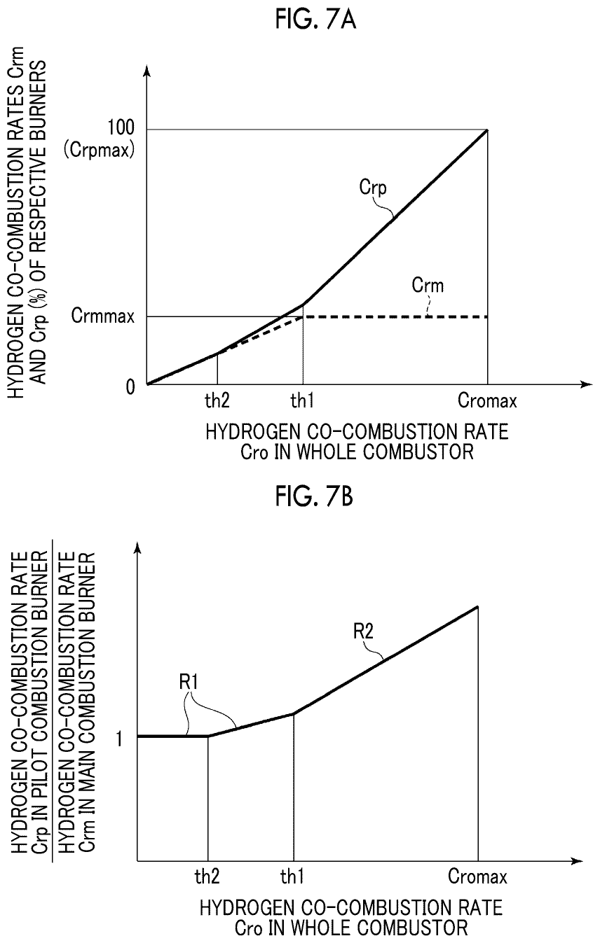

FIG. 7A is a graph illustrating another example of the relationship between the hydrogen co-combustion rates Crm and Crp of the respective combustion burners and the hydrogen co-combustion rate Cro in the whole combustor 4 during a rated operation.

FIG. 7B is a graph illustrating an example of the relationship between the ratio (Crp/Crm) of the hydrogen co-combustion rate Crp in the pilot combustion burner 50 to the hydrogen co-combustion rate Crm in the main combustion burner 60 and the hydrogen co-combustion rate Cro in the whole combustor 4 when the hydrogen co-combustion rates Crm and Crp of the respective combustion burners and the hydrogen co-combustion rate Cro in the whole combustor 4 have the relationship illustrated in FIG. 7A.

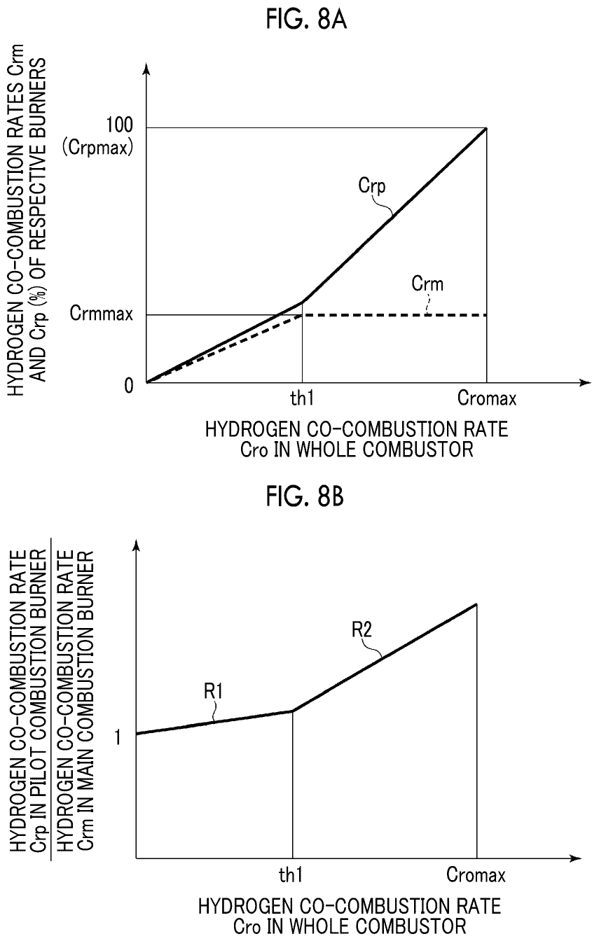

FIG. 8A is a graph illustrating still another example of the relationship between the hydrogen co-combustion rates Crm and Crp of the respective combustion burners and the hydrogen co-combustion rate Cro in the whole combustor 4 during the rated operation.

FIG. 8B is a graph illustrating an example of the relationship between the ratio (Crp/Crm) of the hydrogen co-combustion rate Crp in the pilot combustion burner 50 to the hydrogen co-combustion rate Crm in the main combustion burner 60 and the hydrogen co-combustion rate Cro in the whole combustor 4 when the hydrogen co-combustion rates Crm and Crp of the respective combustion burners and the hydrogen co-combustion rate Cro in the whole combustor 4 have the relationship illustrated in FIG. 8A.

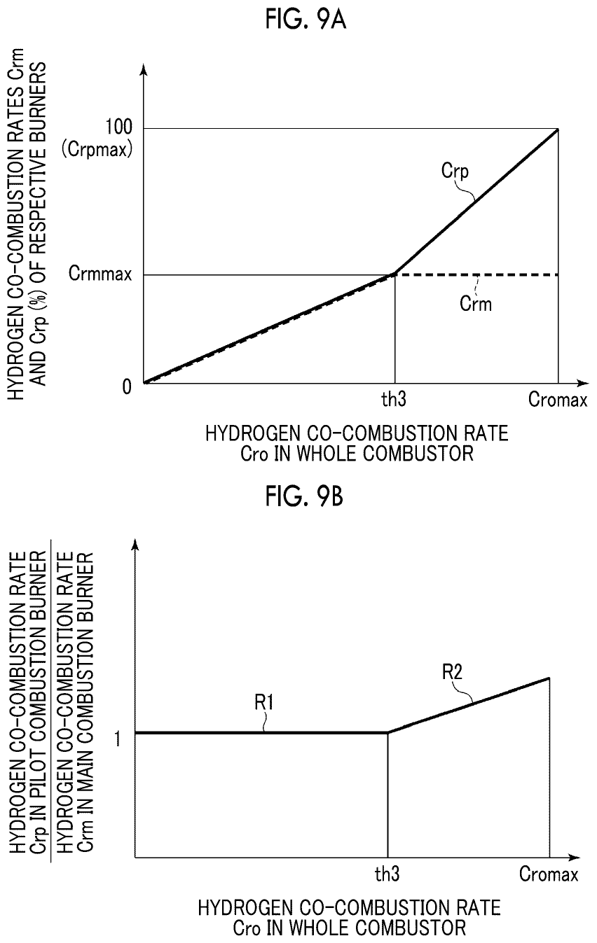

FIG. 9A is a graph illustrating an example of the relationship between the hydrogen co-combustion rates Crm and Crp of the respective combustion burners and the hydrogen co-combustion rate Cro in the whole combustor 4 during a partial load operation.

FIG. 9B is a graph illustrating an example of the relationship between the ratio (Crp/Crm) of the hydrogen co-combustion rate Crp in the pilot combustion burner 50 to the hydrogen co-combustion rate Crm in the main combustion burner 60 and the hydrogen co-combustion rate Cro in the whole combustor 4 when the hydrogen co-combustion rates Crm and Crp of the respective combustion burners and the hydrogen co-combustion rate Cro in the whole combustor 4 have the relationship illustrated in FIG. 9A.

For example, a case will be considered in which the hydrogen co-combustion rate Cro is gradually increased from exclusive combustion (hydrogen co-combustion rate Cro=0%) using the natural gas fuel FN and is co-combusted during a rated operation of the gas turbine 1.

In this case, as illustrated in FIG. 6A, during an operation at a low hydrogen co-combustion rate in which the hydrogen co-combustion rate Cro in the whole combustor 4 is relatively low, the hydrogen co-combustion rates Crm and Crp of the respective combustion burners may gradually increase while taking the same value as the hydrogen co-combustion rate Cro in the whole combustor 4 increases.

For example, a transition of the hydrogen co-combustion rates Crm and Crp of the respective combustion burners can be realized by gradually opening the third regulation valve 243 for regulating the supply amount of the hydrogen fuel FH to the main combustion burner 60 and to the pilot combustion burner 50 while keeping the fourth regulation valve 244 for regulating the supply amount of the hydrogen fuel FH to the pilot combustion burner 50 illustrated in FIG. 5 closed.

In addition, the combustion controller 140 may transmit a control signal to the third regulation valve 243 such that the third regulation valve 243 operates in this manner.

As illustrated in FIG. 6A, after gradually increasing the hydrogen co-combustion rates Crm and Crp of the respective combustion burners while taking the same value, the hydrogen co-combustion rate Crp in the pilot combustion burner 50 may be gradually increased so that the hydrogen co-combustion rate Cro in the whole combustor 4 increases, after the hydrogen co-combustion rate Crm in the main combustion burner 60 reaches the upper limit value Crmmax. That is, during an operation at a high hydrogen co-combustion rate in which the hydrogen co-combustion rate is higher than during the operation at the low hydrogen co-combustion rate, the hydrogen co-combustion rate Cro in the whole combustor 4 may be increased by gradually increasing the hydrogen co-combustion rate Crp in the pilot combustion burner 50.

The transition of the hydrogen co-combustion rates Crm and Crp of the respective combustion burners can be realized, for example, by gradually closing the second regulation valve 242 of the second supply line 212 and gradually opening the fourth regulation valve 244 while keeping the opening degree of the third regulation valve 243 illustrated in FIG. 5 fixed.

In addition, the combustion controller 140 may transmit a control signal to the second regulation valve 242 and to the fourth regulation valve 244 such that the second regulation valve 242 and the fourth regulation valve 244 operate in this manner.

The upper limit value Crpmax of the hydrogen co-combustion rate Crp in the pilot combustion burner 50 may be 100% as illustrated in FIG. 6A and FIGS. 7A, 8A, and 9A to be described later.

For the sake of convenience of description, after gradually increasing the hydrogen co-combustion rates Crm and Crp of the respective combustion burners while taking the same value, with a value th1 of the hydrogen co-combustion rate Cro in the whole combustor 4 when the hydrogen co-combustion rate Crm in the main combustion burner 60 reaches the upper limit value Crmmax, or a value th3 (described later) as a boundary, a case where a value of the hydrogen co-combustion rate Cro is equal to or less than the value th1 or than the value th3 is referred to as an operation at a low hydrogen co-combustion rate, and a case where the value of the hydrogen co-combustion rate Cro exceeds the value th1 or the value th3 is referred to as an operation at a high hydrogen co-combustion rate.

As illustrated in FIG. 6A, in a case where the hydrogen co-combustion rates Crm and Crp of the respective combustion burners are changed, as illustrated in FIG. 6B, in a case where the value of the hydrogen co-combustion rate Cro is equal to or less than the value th1, the ratio (Crp/Crm) of the hydrogen co-combustion rate Crp in the pilot combustion burner 50 to the hydrogen co-combustion rate Crm in the main combustion burner 60 is 1.

As illustrated in FIG. 6A, in a case where the hydrogen co-combustion rates Crm and Crp of the respective combustion burners are changed, as illustrated in FIG. 6B, in a case where the value of the hydrogen co-combustion rate Cro exceeds the value th1, the above-described ratio (Crp/Crm) exceeds 1 and gradually increases as the hydrogen co-combustion rate Cro increases.

In the following description, the above ratio (Crp/Crm) during the operation at the low hydrogen co-combustion rate is referred to as a first ratio R1, and the above ratio (Crp/Crm) during the operation at the high hydrogen co-combustion rate is referred to as a second ratio R2.

In examples illustrated in FIGS. 6A and 6B, in a process of increasing the hydrogen co-combustion rate Cro in the whole combustor 4, the fourth regulation valve 244 for regulating the supply amount of the hydrogen fuel FH to the pilot combustion burner 50 is kept closed until the hydrogen co-combustion rate Crm in the main combustion burner 60 reaches the upper limit value Crmmax. However, in the process of increasing the hydrogen co-combustion rate Cro in the whole combustor 4, the fourth regulation valve 244 may be started to open before the hydrogen co-combustion rate Crm in the main combustion burner 60 reaches the upper limit value Crmmax.

Examples illustrated in FIGS. 7A and 7B are examples in a case where the fourth regulation valve 244 is started to open from a time when the hydrogen co-combustion rate Crm in the main combustion burner 60 reaches a value th2 (th2<th1) smaller than the value th1, in the process of increasing the hydrogen co-combustion rate Cro in the whole combustor 4.

In the example illustrated in FIG. 7A, in the process of increasing the hydrogen co-combustion rate Cro in the whole combustor 4, until the hydrogen co-combustion rate Cro in the whole combustor 4 reaches the value th2, the hydrogen co-combustion rates Crm and Crp of the respective combustion burners gradually increase while taking the same value as the hydrogen co-combustion rate Cro in the whole combustor 4 increases.

In the example illustrated in FIG. 7A, after the hydrogen co-combustion rate Cro in the whole combustor 4 reaches the value th2, until the hydrogen co-combustion rate Cro in the whole combustor 4 reaches the value th1, while the hydrogen co-combustion rate Crp in the pilot combustion burner 50 takes a value larger than the hydrogen co-combustion rate Crm in the main combustion burner 60, a difference between both gradually increases as the hydrogen co-combustion rate Cro in the whole combustor 4 increases.

In the example illustrated in FIG. 7A, in the process of increasing the hydrogen co-combustion rate Cro in the whole combustor 4, after the hydrogen co-combustion rate Cro in the whole combustor 4 reaches the value th1, the hydrogen co-combustion rate Crm in the main combustion burner 60 is the upper limit value Crmmax, and the hydrogen co-combustion rate Crp in the pilot combustion burner 50 gradually increases. That is, in the example illustrated in FIG. 7A, in the process of increasing the hydrogen co-combustion rate Cro in the whole combustor 4, after the hydrogen co-combustion rate Cro in the whole combustor 4 reaches the value th1, for example, while keeping the opening degree of the third regulation valve 243 illustrated in FIG. 5 fixed, the second regulation valve 242 of the second supply line 212 may be gradually closed and the fourth regulation valve 244 may be gradually opened.

As illustrated in FIG. 7A, in a case where the hydrogen co-combustion rates Crm and Crp of the respective combustion burners are changed, as illustrated in FIG. 7B, in a case where the value of the hydrogen co-combustion rate Cro is equal to or less than the value th2, the ratio (Crp/Crm) of the hydrogen co-combustion rate Crp in the pilot combustion burner 50 to the hydrogen co-combustion rate Crm in the main combustion burner 60 is 1.

As illustrated in FIG. 7A, in a case where the hydrogen co-combustion rates Crm and Crp of the respective combustion burners are changed, as illustrated in FIG. 7B, in a case where the value of the hydrogen co-combustion rate Cro exceeds the value th2, the above-described ratio (Crp/Crm) exceeds 1 and gradually increases as the hydrogen co-combustion rate Cro increases.

In the examples illustrated in FIGS. 7A and 7B, in the process of increasing the hydrogen co-combustion rate Cro in the whole combustor 4, the fourth regulation valve 244 for regulating the supply amount of the hydrogen fuel FH to the pilot combustion burner 50 is kept closed until the hydrogen co-combustion rate Cro in the whole combustor 4 reaches the value th2. However, in the process of increasing the hydrogen co-combustion rate Cro in the whole combustor 4, the fourth regulation valve 244 may be started to open at the same time as the third regulation valve 243 is started to open.

Examples illustrated in FIGS. 8A and 8B are examples in a case where the fourth regulation valve 244 is started to open at the same time as the third regulation valve 243 is started to open in the process of increasing the hydrogen co-combustion rate Cro in the whole combustor 4.

In the example illustrated in FIG. 8A, in the process of increasing the hydrogen co-combustion rate Cro in the whole combustor 4, until the hydrogen co-combustion rate Cro in the whole combustor 4 reaches the value th1, while the hydrogen co-combustion rate Crp in the pilot combustion burner 50 takes a value larger than the hydrogen co-combustion rate Crm in the main combustion burner 60, the difference between both gradually increases as the hydrogen co-combustion rate Cro in the whole combustor 4 increases.

In the example illustrated in FIG. 8A, in the process of increasing the hydrogen co-combustion rate Cro in the whole combustor 4, after the hydrogen co-combustion rate Cro in the whole combustor 4 reaches the value th1, the hydrogen co-combustion rate Crm in the main combustion burner 60 is the upper limit value Crmmax, and the hydrogen co-combustion rate Crp in the pilot combustion burner 50 gradually increases. That is, in the example illustrated in FIG. 8A, in the process of increasing the hydrogen co-combustion rate Cro in the whole combustor 4, after the hydrogen co-combustion rate Cro in the whole combustor 4 reaches the value th1, for example, while keeping the opening degree of the third regulation valve 243 illustrated in FIG. 5 fixed, the second regulation valve 242 of the second supply line 212 may be gradually closed and the fourth regulation valve 244 may be gradually opened.

As illustrated in FIG. 8A, in a case where the hydrogen co-combustion rates Crm and Crp of the respective combustion burners are changed, as illustrated in FIG. 8B, the ratio (Crp/Crm) of the hydrogen co-combustion rate Crp in the pilot combustion burner 50 to the hydrogen co-combustion rate Crm in the main combustion burner 60 exceeds 1 and gradually increases as the hydrogen co-combustion rate Cro in the whole combustor 4 increases.

### In Case of During Partial Load Operation

In general, as a load of the gas turbine 1 increases, the supply amount of the fuel F increases, so that the risk of the backfire increases. On the contrary, during a partial load operation of the gas turbine 1, a risk of backfire of the hydrogen fuel is smaller than during the rated operation of the gas turbine 1. Therefore, the maximum value Cromax of the hydrogen co-combustion rate Cro in the whole combustor 4 during the partial load operation can be increased compared to during the rated operation.

As described above, the upper limit value Crpmax of the hydrogen co-combustion rate Crp in the pilot combustion burner 50 is 100% during the rated operation as illustrated in FIGS. 6A, 7A, and 8A. Therefore, there is no room for raising the upper limit value Crpmax of the hydrogen co-combustion rate Crp in the pilot combustion burner 50.

Therefore, in the operation method for a gas turbine according to some embodiments, as illustrated in FIGS. 9A and 9B, the upper limit value Crmmax of the hydrogen co-combustion rate Crm in the main combustion burner 60 during the partial load operation is set to be larger than during the rated operation, so that the maximum value Cromax of the hydrogen co-combustion rate Cro in the whole combustor 4 during the partial load operation is set to be larger than during the rated operation.

That is, in the operation method for a gas turbine according to some embodiments, as is clear from a comparison between FIG. 9A and, for example, FIG. 6A, the upper limit value Crmmax of the hydrogen co-combustion rate Crm in the main combustion burner 60 during the partial load operation is set to be larger than during the rated operation.

For example, a case will be considered in which the hydrogen co-combustion rate Cro is gradually increased from the exclusive combustion (hydrogen co-combustion rate Cro=0%) using the natural gas fuel FN and is co-combusted during the partial load operation of the gas turbine 1.

In this case, as illustrated in FIG. 9A, during the operation at the low hydrogen co-combustion rate in which the hydrogen co-combustion rate Cro in the whole combustor 4 is relatively low, the hydrogen co-combustion rates Crm and Crp of the respective combustion burners may gradually increase while taking the same value as the hydrogen co-combustion rate Cro in the whole combustor 4 increases.

As illustrated in FIG. 9A, after gradually increasing the hydrogen co-combustion rates Crm and Crp of the respective combustion burners while taking the same value, the hydrogen co-combustion rate Crp in the pilot combustion burner 50 may be gradually increased so that the hydrogen co-combustion rate Cro in the whole combustor 4 increases, after the hydrogen co-combustion rate Crm in the main combustion burner 60 reaches the upper limit value Crmmax. That is, during the operation at the high hydrogen co-combustion rate in which the hydrogen co-combustion rate is higher than during the operation at the low hydrogen co-combustion rate, the hydrogen co-combustion rate Cro in the whole combustor 4 may be increased by gradually increasing the hydrogen co-combustion rate Crp in the pilot combustion burner 50.

In an example illustrated in FIG. 9A, in the process of increasing the hydrogen co-combustion rate Cro in the whole combustor 4, after the hydrogen co-combustion rate Cro in the whole combustor 4 reaches the value th3, for example, while keeping the opening degree of the third regulation valve 243 illustrated in FIG. 5 fixed, the second regulation valve 242 of the second supply line 212 may be gradually closed and the fourth regulation valve 244 may be gradually opened.

As illustrated in FIG. 9A, in a case where the hydrogen co-combustion rates Crm and Crp of the respective combustion burners are changed, as illustrated in FIG. 9B, in a case where the value of the hydrogen co-combustion rate Cro is equal to or less than the value th3 (during the operation at the low hydrogen co-combustion rate), the ratio (Crp/Crm) of the hydrogen co-combustion rate Crp in the pilot combustion burner 50 to the hydrogen co-combustion rate Crm in the main combustion burner 60 is 1.

As illustrated in FIG. 9A, in a case where the hydrogen co-combustion rates Crm and Crp of the respective combustion burners are changed, as illustrated in FIG. 9B, in a case where the value of the hydrogen co-combustion rate Cro exceeds the value th3 (during the operation at the high hydrogen co-combustion rate), the above-described ratio (Crp/Crm) exceeds 1 and gradually increases as the hydrogen co-combustion rate Cro increases.

The lower a gas turbine inlet combustion gas temperature TIT, the larger the upper limit value Crmmax of the hydrogen co-combustion rate Crm in the main combustion burner 60 may be.

### Summary of Operation Method for Gas Turbine According to Some Embodiments

Contents described in each of the above embodiments will be summarized below.

The operation method for a gas turbine according to some embodiments is an operation method for the gas turbine 1 including the combustor 4 that has the main nozzle 64 and the pilot nozzle 54 and that is capable of using hydrogen and fuel other than hydrogen as fuel. As illustrated in FIGS. 6B, 7B, 8B, and 9B, the ratio (Crp/Crm) of the hydrogen co-combustion rate Crp of the fuel F injected from the pilot nozzle 54 to the hydrogen co-combustion rate Crm of the fuel F injected from the main nozzle 64 is larger in the second ratio R2 during the operation at the high hydrogen co-combustion rate, in which the hydrogen co-combustion rate Cro in the whole combustor 4 is higher than during the operation at the low hydrogen co-combustion rate, than in the first ratio R1 during the operation at the low hydrogen co-combustion rate.

For example, in a case where the pilot combustion burner 50 is less likely to cause the backflow of the flame, or the like than the main combustion burner 60, when the hydrogen co-combustion rate Cro in the whole combustor 4 is increased, the risk of the backfire can be reduced by making the hydrogen co-combustion rate Crp of the fuel F injected from the pilot combustion burner 50 higher than the hydrogen co-combustion rate Crm of the fuel F injected from the main combustion burner 60.

According to the operation method for a gas turbine according to some embodiments, in a case where the pilot combustion burner 50 is less likely to cause the backfire than the main combustion burner 60, the gas turbine can be operated at the high hydrogen co-combustion rate Cro while suppressing the backfire.

In the operation method for a gas turbine according to some embodiments, as illustrated in FIGS. 6B, 7B, 8B, and 9B, the second ratio R2 may increase as the hydrogen co-combustion rate (hydrogen co-combustion rate Cro in the whole combustor 4) of the fuel F supplied to the combustor 4 increases.

In this manner, during the operation at the high hydrogen co-combustion rate, by increasing the hydrogen co-combustion rate Crp of the pilot combustion burner 50 while suppressing the hydrogen co-combustion rate Crm of the main combustion burner 60 to suppress the backfire, the hydrogen co-combustion rate Cro in the whole combustor 4 can be increased.

In the operation method for a gas turbine according to some embodiments, as illustrated in FIGS. 6A, 7A, 8A, and 9A, during the operation at the high hydrogen co-combustion rate, the hydrogen co-combustion rate Crp of the fuel F injected from the pilot combustion burner 50 may increase as the hydrogen co-combustion rate (hydrogen co-combustion rate Cro in the whole combustor 4) of the fuel F supplied to the combustor 4 increases.

In this manner, during the operation at the high hydrogen co-combustion rate, while increasing the hydrogen co-combustion rate Crp of the pilot combustion burner 50 to suppress the backfire, the hydrogen co-combustion rate Cro in the whole combustor 4 can be increased.

In the operation method for a gas turbine according to some embodiments, as illustrated in FIGS. 6A, 7A, 8A, and 9A, during the operation at the high hydrogen co-combustion rate, an increase rate of the hydrogen co-combustion rate Crp of the fuel F injected from the pilot combustion burner 50 to an increase rate of the hydrogen co-combustion rate (hydrogen co-combustion rate Cro in the whole combustor 4) of the fuel F supplied to the combustor 4 may be larger than an increase rate of the hydrogen co-combustion rate Crm of the fuel F injected from the main combustion burner 60 to the increase rate of the hydrogen co-combustion rate (hydrogen co-combustion rate Cro in the whole combustor 4) of the fuel F supplied to the combustor 4.

A fact that the increase rate of the hydrogen co-combustion rate Crp to the increase rate of the hydrogen co-combustion rate Cro is larger than the increase rate of the hydrogen co-combustion rate Crm to the increase rate of the hydrogen co-combustion rate Cro is equivalent to a fact that a slope of a graph line of the hydrogen co-combustion rate Crp is larger than a slope of a graph line of the hydrogen co-combustion rate Crm in FIGS. 6A, 7A, 8A, and 9A.

In the operation method for a gas turbine according to some embodiments, as illustrated in FIGS. 6A, 7A, 8A, and 9A, during the operation at the high hydrogen co-combustion rate, that is, when the value of the hydrogen co-combustion rate Cro exceeds the value th1 or the value th3, the slope of the graph line of the hydrogen co-combustion rate Crp is larger than the slope of the graph line of the hydrogen co-combustion rate Crm.

In this manner, during the operation at the high hydrogen co-combustion rate, by increasing the hydrogen co-combustion rate Crp of the pilot combustion burner 50 while suppressing the hydrogen co-combustion rate Crm of the main combustion burner 60 to suppress the backfire, the hydrogen co-combustion rate Cro in the whole combustor 4 can be increased.

In the operation method for a gas turbine according to some embodiments, as illustrated in FIGS. 6A, 7A, 8A, and 9A, during the operation at the high hydrogen co-combustion rate, the hydrogen co-combustion rate Crm of the fuel F injected from the main combustion burner 60 may be a constant value regardless of the hydrogen co-combustion rate (hydrogen co-combustion rate Cro in the whole combustor 4) of the fuel F supplied to the combustor 4.

In this manner, during the operation at the high hydrogen co-combustion rate, by increasing the hydrogen co-combustion rate Crp of the pilot combustion burner 50 while keeping the hydrogen co-combustion rate Crm of the main combustion burner 60 constant to suppress the backfire, the hydrogen co-combustion rate Cro in the whole combustor 4 can be increased.

In the operation method for a gas turbine according to some embodiments, as illustrated in FIGS. 6A, 7A, 8A, and 9A, the upper limit value Crpmax of the hydrogen co-combustion rate Crp of the fuel F injected from the pilot combustion burner 50 may be 100%.

In this manner, the hydrogen co-combustion rate Crp of the pilot combustion burner 50 can be set to 100% while suppressing the backfire in the combustor 4, and a hydrogen co-combustion rate Cro in the whole combustor 4 can be increased.

In the operation method for a gas turbine according to some embodiments, as illustrated in FIGS. 6A, 7A, and 9A, the first ratio R1 may be 1 in at least a part of a period during the operation at the low hydrogen co-combustion rate.

Accordingly, since the hydrogen co-combustion rate Crm of the fuel F injected from the main combustion burner 60 and the hydrogen co-combustion rate Crp of the fuel F injected from the pilot combustion burner 50 are equal to each other, the supply system 200 for the fuel F to the main combustion burner 60 and to the pilot combustion burner 50 can be shared as illustrated in FIG. 5, and thus the supply system 200 for the fuel F can be simplified.

In the operation method for a gas turbine according to some embodiments, as illustrated in FIGS. 6A and 9A, the upper limit value Crmmax of the hydrogen co-combustion rate Crm of the fuel F injected from the main combustion burner 60 may be larger during the partial load operation of the gas turbine 1 than during the rated operation of the gas turbine 1.

A risk of backfire of the hydrogen fuel FH is smaller during the partial load operation of the gas turbine 1 than during the rated operation of the gas turbine 1. Therefore, the maximum value Cromax of the hydrogen co-combustion rate Cro in the whole combustor 4 during the partial load operation can be increased compared to during the rated operation. According to the operation method for a gas turbine according to some embodiments, the upper limit value Crmmax of the hydrogen co-combustion rate Crm of the main combustion burner 60 during the partial load operation is set to be larger than during the rated operation, so that the maximum value Cromax of a total hydrogen co-combustion rate (hydrogen co-combustion rate Cro in the whole combustor 4) during the partial load operation can be set to be larger than during the rated operation.

In addition, according to the operation method for a gas turbine in some embodiments, even in a case where the hydrogen co-combustion rate Crp in the pilot combustion burner 50 is 100% and the hydrogen co-combustion rate Crp cannot be increased any further in the pilot combustion burner 50, the hydrogen co-combustion rate Cro in the whole combustor 4 can be increased.

In the operation method for a gas turbine according to some embodiments, as illustrated in FIGS. 2, 3, and 4, the combustor 4 may include the main combustion burner 60 having the main nozzle 64 and the pilot combustion burner 50 having the pilot nozzle 54. The main combustion burner 60 may be a pre-mixed combustion type burner, and the pilot combustion burner 50 may be a diffusion combustion type burner.

Accordingly, the risk of the backfire is smaller in the diffusion combustion type burner than in the pre-mixed combustion type burner. Therefore, the upper limit value Crpmax of the hydrogen co-combustion rate Crp of the pilot combustion burner 50 can be increased, and the total hydrogen co-combustion rate (hydrogen co-combustion rate Cro in the whole combustor 4) can be increased.

In the operation method for a gas turbine according to some embodiments, the pilot combustion burner 50 may have the flow path of the water and be configured to inject the water.

In this manner, the flame temperature can be suppressed, and the NOₓ can be suppressed and the metal temperature of the pilot combustion burner 50 (cone portion 56b) can be suppressed.

The present disclosure is not limited to the above-described embodiments, and also includes a form in which modifications are added to the above-described embodiments or a form in which the embodiments are combined with each other as appropriate.

For example, in the operation method for a gas turbine according to some of the above-described embodiments, in a range of at least a part of the hydrogen co-combustion rate Cro in which the value of the hydrogen co-combustion rate Cro is equal to or less than the value th1 or than the value th3, the ratio (Crp/Crm) of the hydrogen co-combustion rate Crp in the pilot combustion burner 50 to the hydrogen co-combustion rate Crm in the main combustion burner 60 may be less than 1.

For example, contents described in each of the above-described embodiments are understood as follows.
(1) An operation method for a gas turbine 1 according to at least one embodiment of the present disclosure is an operation method for a gas turbine 1 including a combustor 4 that has a main nozzle 64 and a pilot nozzle 54 and that is capable of using, as fuel, hydrogen and fuel other than hydrogen. A ratio (Crp/Crm) of a hydrogen co-combustion rate (Crp) of the fuel F injected from the pilot nozzle 54 to a hydrogen co-combustion rate (Crm) of the fuel F injected from the main nozzle 64 is larger in a second ratio R2 during an operation at a high hydrogen co-combustion rate, in which a hydrogen co-combustion rate (Cro) is higher than during an operation at a low hydrogen co-combustion rate, than in a first ratio RI during the operation at the low hydrogen co-combustion rate.

For example, in a case where the pilot nozzle 54 is less likely to cause the backfire than the main nozzle 64, when the hydrogen co-combustion rate Cro in the whole combustor 4 is increased, the risk of the backfire can be reduced by making the hydrogen co-combustion rate (Crp) of the fuel F injected from the pilot nozzle 54 higher than the hydrogen co-combustion rate (Crm) of the fuel F injected from the main nozzle 64.

According to the method of (1) above, in a case where the pilot nozzle 54 is less likely to cause the backflow of the flame, or the like than the main nozzle 64, the gas turbine 1 can be operated at the high hydrogen co-combustion rate (Cro) while suppressing the backfire.
(2) In some embodiments, in the method of (1) above, the second ratio R2 may increase as the hydrogen co-combustion rate (Cro) of the fuel F supplied to the combustor 4 increases.

According to the method of (2) above, during the operation at the high hydrogen co-combustion rate, by increasing the hydrogen co-combustion rate (Crp) of the pilot nozzle 54 while suppressing the hydrogen co-combustion rate (Crm) of the main nozzle 64 to suppress the backfire, the hydrogen co-combustion rate Cro in the whole combustor 4 can be increased.
(3) In some embodiments, in the method of (2) above, during the operation at the high hydrogen co-combustion rate, the hydrogen co-combustion rate (Crp) of the fuel F injected from the pilot nozzle 54 may increase as the hydrogen co-combustion rate (Cro) of the fuel F supplied to the combustor 4 increases.

According to the method of (3) above, during the operation at the high hydrogen co-combustion rate, while increasing the hydrogen co-combustion rate (Crp) of the pilot nozzle 54 to suppress the backfire, the hydrogen co-combustion rate Cro in the whole combustor 4 can be increased.
(4) In some embodiments, in the method of (2) or (3) above, during the operation at the high hydrogen co-combustion rate, an increase rate of the hydrogen co-combustion rate (Crp) of the fuel F injected from the pilot nozzle 54 to an increase rate of the hydrogen co-combustion rate (Cro) of the fuel F supplied to the combustor 4 may be larger than an increase rate of the hydrogen co-combustion rate (Crm) of the fuel F injected from the main nozzle 64 to the increase rate of the hydrogen co-combustion rate (Cro) of the fuel F supplied to the combustor 4.

According to the method of (4) above, during the operation at the high hydrogen co-combustion rate, by increasing the hydrogen co-combustion rate (Crp) of the pilot nozzle 54 while suppressing the hydrogen co-combustion rate (Crm) of the main nozzle 64 to suppress the backfire, the hydrogen co-combustion rate Cro in the whole combustor 4 can be increased.
(5) In some embodiments, in the method of (4) above, during the operation at the high hydrogen co-combustion rate, the hydrogen co-combustion rate (Crm) of the fuel F injected from the main nozzle 64 may be a constant value regardless of the hydrogen co-combustion rate (Cro) of the fuel F supplied to the combustor 4.

According to the method of (5) above, during the operation at the high hydrogen co-combustion rate, by increasing the hydrogen co-combustion rate (Crp) of the pilot nozzle 54 while keeping the hydrogen co-combustion rate (Crm) of the main nozzle 64 constant to suppress the backfire, the hydrogen co-combustion rate Cro in the whole combustor 4 can be increased.
(6) In some embodiments, in the method of any one of (1) to (5) above, an upper limit value (Crpmax) of the hydrogen co-combustion rate (Crp) of the fuel F injected from the pilot nozzle 54 may be 100%.

According to the method of (6) above, the hydrogen co-combustion rate (Crp) of the pilot nozzle 54 can be set to 100% while suppressing the backfire in the combustor 4, and the hydrogen co-combustion rate Cro in the whole combustor 4 can be increased.
(7) In some embodiments, in the method of any one of (1) to (6) above, the first ratio R1 may be 1 in at least a part of a period during the operation at the low hydrogen co-combustion rate.

According to the method of (7) above, since the hydrogen co-combustion rate (Crm) of the fuel F injected from the main nozzle 64 and the hydrogen co-combustion rate (Crp) of the fuel F injected from the pilot nozzle 54 are equal to each other, the supply system 200 for the fuel F to the main nozzle 64 and to the pilot nozzle 54 can be shared, and thus the supply system 200 for the fuel F can be simplified.
(8) In some embodiments, in the method of any one of (1) to (7) above, an upper limit value (Crmmax) of the hydrogen co-combustion rate (Crm) of the fuel F injected from the main nozzle 64 may be larger during a partial load operation of the gas turbine 1 than during a rated operation of the gas turbine 1.

The risk of backfire of the hydrogen fuel FH is smaller during the partial load operation of the gas turbine 1 than during the rated operation of the gas turbine 1. Therefore, the maximum value Cromax of the hydrogen co-combustion rate Cro in the whole combustor 4 during the partial load operation can be increased compared to during the rated operation. According to the method of (8) above, the upper limit value (Crmmax) of the hydrogen co-combustion rate (Crm) of the main nozzle 64 during the partial load operation is set to be larger than during the rated operation, so that the maximum value (Cromax) of the total hydrogen co-combustion rate (Cro) during the partial load operation can be set to be larger than during the rated operation.
(9) In some embodiments, in the method of any one of (1) to (8) above, the combustor 4 may include a main combustion burner 60 having the main nozzle 64 and a pilot combustion burner 50 having the pilot nozzle 54. The main combustion burner 60 may be a pre-mixed combustion type burner, and the pilot combustion burner 50 may be a diffusion combustion type burner.

According to the method of (9) above, the risk of the backfire is smaller in the diffusion combustion type burner than in the pre-mixed combustion type burner. Therefore, the upper limit value (Crpmax) of the hydrogen co-combustion rate (Crp) of the pilot combustion burner 50 can be increased, and the total hydrogen co-combustion rate (Cro) can be increased.
(10) In some embodiments, in the method of any one of (1) to (9) above, the pilot nozzle 54 may have a flow path of water and be configured to inject the water.

According to the method of (10) above, the flame temperature can be suppressed, and the NOₓ can be suppressed and the metal temperature of the pilot combustion burner 50 (cone portion 56b) can be suppressed.

### REFERENCE SIGNS LIST

1: gas turbine
4: gas turbine combustor (combustor)
50: pilot combustion burner
54: pilot nozzle
60: main combustion burner
64: main nozzle
200: supply system

1. An operation method for a gas turbine including a combustor that has a main nozzle and a pilot nozzle and that is capable of using, as fuel, hydrogen and fuel other than hydrogen,
wherein a ratio of a hydrogen co-combustion rate of the fuel injected from the pilot nozzle to a hydrogen co-combustion rate of the fuel injected from the main nozzle is larger in a second ratio during an operation at a high hydrogen co-combustion rate, in which a hydrogen co-combustion rate is higher than during an operation at a low hydrogen co-combustion rate, than in a first ratio during the operation at the low hydrogen co-combustion rate.

2. The operation method for a gas turbine according to claim 1,
wherein the second ratio increases as the hydrogen co-combustion rate of the fuel supplied to the combustor increases.

3. The operation method for a gas turbine according to claim 2,
wherein, during the operation at the high hydrogen co-combustion rate, the hydrogen co-combustion rate of the fuel injected from the pilot nozzle increases as the hydrogen co-combustion rate of the fuel supplied to the combustor increases.

4. The operation method for a gas turbine according to claim 2,
wherein, during the operation at the high hydrogen co-combustion rate, an increase rate of the hydrogen co-combustion rate of the fuel injected from the pilot nozzle to an increase rate of the hydrogen co-combustion rate of the fuel supplied to the combustor is larger than an increase rate of the hydrogen co-combustion rate of the fuel injected from the main nozzle to the increase rate of the hydrogen co-combustion rate of the fuel supplied to the combustor.

5. The operation method for a gas turbine according to claim 4,
wherein, during the operation at the high hydrogen co-combustion rate, the hydrogen co-combustion rate of the fuel injected from the main nozzle is a constant value regardless of the hydrogen co-combustion rate of the fuel supplied to the combustor.

6. The operation method for a gas turbine according to claim 1,
wherein an upper limit value of the hydrogen co-combustion rate of the fuel injected from the pilot nozzle is 100%.

7. The operation method for a gas turbine according to claim 1,
wherein the first ratio is 1 in at least a part of a period during the operation at the low hydrogen co-combustion rate.

8. The operation method for a gas turbine according to claim 1,
wherein an upper limit value of the hydrogen co-combustion rate of the fuel injected from the main nozzle is larger during a partial load operation of the gas turbine than during a rated operation of the gas turbine.

9. The operation method for a gas turbine according to claim 1,
wherein the combustor includes a main combustion burner having the main nozzle and a pilot combustion burner having the pilot nozzle,
the main combustion burner is a pre-mixed combustion type burner, and
the pilot combustion burner is a diffusion combustion type burner.

10. The operation method for a gas turbine according to claim 1,
wherein the pilot nozzle has a flow path of water and is configured to inject the water.
